(19) United States
(12) Patent Application Publication
(10) Pub. No.: US 2005/0014853 A1
(43) Pub. Date: Jan. 20, 2005

(54) Solventless sulfonation of exchange resins

(76) Inventors: Randy S. Tesch, Saginaw, MI (US); Marvin H. Tegen, Midland, MI (US); William I. Harris, Midland, MI (US)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/885,255

(22) Filed: Jul. 6, 2004

Related U.S. Application Data
(60) Provisional application No. 60/485,166, filed on Jul. 7, 2003.

(51) Int. Cl. C08J 5/20

(52) U.S. Cl. 521/25

(57) ABSTRACT

A process for the preparation of styrene-divinylbenzene gel cationic exchange resins by sulfonation in sulfuric acid, without the addition of a swelling agent or acrylic co-monomers, with relatively fast hydration rate. The use of temperature and acid concentration to increase the rate of sulfonation while controlling the side reaction of sulfone bridging minimizes reaction time while maximizing bead quality.

This application claims the benefit of U.S. Provisional Patent Application Ser. No. 60/485,166, filed Jul. 7, 2003.

### BACKGROUND OF INVENTION

Industrially useful cation exchangers are well known in the art. D'Alelio in U.S. Pat. No. 2,366,007, first describes cation exchange resins based on sulfonated styrene-divinylbenzene copolymer. Boyer, in U.S. Pat. No. 2,500,149, describes the use of swelling solvents during sulfonation. The use of solvents, especially chlorinated solvents in gel cation exchange resin processes, has been a preferred method, and results in mechanically and osmotically stable cation exchange resins, with low bead breakage. The most common solvent used in gel cation exchange resin processes is 1,2-dichloroethane. U.S. Pat. No. 5,248,435 teaches the use of sulfonating porous styrene-divinylbenzene copolymers with the addition of chlorine-containing swelling agents with a 95 percent strength sulfuric acid at 80° C. However, chlorinated solvents have become regarded as less safe than in the past. The continued use of 1,2 dichloroethane now presents two problems: residual solvent in the gel cation exchange resin product, and increasing expense in handling solvents in an environmentally safe manner.

One problem of sulfonating without the use of solvent is the time needed for the reaction. Without solvent to soften the copolymer bead, the reaction between the polymer and the acid is slower. In a production facility, it may take several hours for sulfonation to complete when no solvent is used. In a plant that is running near capacity in a batch or semi-batch mode, it is important to reduce the time for any one batch, particularly where different products are made in the same equipment. One method for increasing the sulfonation rate might be to increase the initial acid concentration. However, this has not been supported in the literature; see Bachmann et al., in U.S. Pat. No 6,228,896. The inventors have observed that at higher initial acid concentrations, the consumption of sulfur trioxide from the sulfuric acid is higher than theoretical, and the reaction rate increases. Another method of increasing the sulfonation rate would be to raise the reaction temperature.

Another problem with solventless sulfonation is getting beads that are mechanically and osmotically stable. In many applications for cation exchangers, resins are subjected to osmotic stresses that cause substantial breakage in the beads. The breakage of beads causes substantial losses in the efficiency of an ion exchange column packed with such beads, and large costs in replacing the broken resins. A process for making copolymers yield ion exchange resins with good osmotic and mechanical properties is described by Harris, in U.S. Pat. No. 4,564,644 and U.S. Pat. No. 5,068,255 which is incorporated here for reference. Beads are prepared by forming a polymeric matrix containing a plurality of free radicals, and continuously adding to the polymeric matrix, under conditions suitable for polymerizing, a monomer feed which is imbibed by and polymerized within the matrices.

An early method of improving bead strength has been to add small amounts of acrylates to the styrene-divinylbenzene copolymer. Misaka et al. is U.S. Pat. No. 4,500,643 teach a process for producing a cation exchange resin which comprises suspension polymerizing a monomeric mixture comprising styrene, 0.8 to 55 mole percent divinylbenzene per mole of styrene, and 2 to 20 mole percent, per mole of styrene of acrylic or methacrylic acid and/or its lower alkyl ester, and sulfonating the resulting copolymer particles. The sulfonation is performed by stirring the copolymer particles in 95 to 100 percent sulfuric acid. The amount of sulfuric acid is 3 to 30 times the weight of the copolymer the sulfonation is carried out at a temperature of 50° to 150° C., preferably 90° to 110° C. for about 3 to 30 hours. The ion exchange capacity per gram of resin in the examples was 4.5 mili-equivalents. The ratio of particles having cracks present ranged from 5 to 10 percent.

Bachmann, et al. teach a method of preparing mechanically and osmotically stable acidic cation exchangers by sulfonation without the use of chlorine-containing swelling agents or comonomers such as acrylonitrile or methacrylonitrile, in U.S. Pat. No. 6,228,896, to produce beads similar to those produced with solvent. The method uses 80 to 96 percent sulfuric acid, at 125 to 180° C., with sulfonation times up to 20 hours. Reaction times of 8 to 12 hours for gel bead polymers are taught at temperatures in excess of 160° C., using sulfuric acid concentrations below 88 percent. These conditions produced cation exchange resins of similar quality to cation exchange resins produced with swelling solvent.

In US Patent Application Publication 2002/0022671 A1, Klipper et al. describe a process of preparing strongly acidic ion exchangers by subjecting the sulfonated bead polymer to cycles of stepwise dilution with sulfuric acids of decreasing concentration. Their method is for macroporous monodisperse, macroporous heterodisperse, or monodisperse-gel-type cation exchangers. The process taught comprises (a) feeding the bead polymer without swelling agents, into sulfuiwc acid at temperatures from 110° C. to 140° C., (b) stirring at 110° C. to 140° C. until complete sulfonation takes place (c) subjecting the sulfonated bead polymer to cycles of stepwise dilution with sulfuric acids of decreasing concentration, and (d) washing the bead polymer with demineralized water. The stepwise decrease of acid concentration used to wash the sulfonated beads adds time to the total production cycle.

In US Patent Application Publication 2004/0006145 A1, Dimotsis, et al. describe a sulfonation process of crosslinked, (meth) acrylic ester-containing bead polymers with sulfuric acid having a concentration of 90 to 95 percent in the absence of a swelling agent. This patent teaches diluting new sulfuric acid with the recovered (lower concentration) sulfuric acid used in prior sulfonations in the presence of the copolymer. The sulfonation is initiated at temperatures of 40 to 120° C. and increased by exploiting the heat of reaction and/or heat of dilution that occurs during the process up to an end temperature of 150 to 170° C. The ratio of sulfuric acid to bead polymer is 2.5 to 5 ml/g. In addition to the use of acrylate in the copolymer, Dimotsis et al. use a stepwise hydration, starting with 78 percent strength sulfuric acid followed less concentrated acid solutions, in the manner taught by Klipper et al.

An objective of this invention is to produce a gel cation exchange resin product of high quality, without the use of solvent, with a short sulfonation time, preferably less than eight hours.

### SUMMARY OF INVENTION

The present invention is a process for the preparation of styrene-divinylbenzene gel cationic exchange resins by sulfonation in sulfuric acid, without the addition of a swelling agent or acrylic co-monomers, resulting in resins of high quality even when hydrated at a relatively fast hydration rate. Surprisingly, the number of unbroken beads is reduced by having an initial acid concentration of about 88 to 96 percent, and preferably 88 to 92 percent. Surprisingly, the consumption of sulfuric acid is also reduced to that necessary for sulfonic acid group formation as the initial concentration of sulfuric acid approaches 92 percent or less. The rate of reaction is maintained by adding more concentrated acid and/or increasing the reaction temperature as the reaction progresses. The inventors have discovered that heating the sulfonation mixture at rates of 8° to 15° C. per minute to about 10 to 50° C. above the glass transition temperature (T_{g}) of the copolymer and monomer mixture results in better quality and faster reaction time. However, since this may not be practical on a large scale, the alternative of heating the sulfuric acid alone to such a temperature prior to adding the copolymer beads was developed as an alternative. Sulfonated resin beads of this invention may be hydrated by continuously decreasing the concentration of the acid surrounding the beads at up to about 12 percent per minute with as surprisingly high numbers of whole, uncracked beads (WUBs) without use of washes with stepwise decrease of sulfuric acid concentration, for a shorter cationic resin production time.

### DRAWINGS

FIG. 1 illustrates the results of sulfonation of 8 percent divinylbenzene resin with 20/45 US mesh size was carried out at three different initial acid concentrations, at 140° C.

FIG. 2 illustrates the sensitivity of polymer strength to sulfonation temperature and the parentage of whole, uncracked beads using 1.8 percent per minute hydration rate −5×5 20/45, solvent less sulfonation heating 1° C. per minute to 130° C. to 140° C.

FIG. 3 illustrates effect of sulfonating at a higher temperature at three different acid levels.

FIG. 4 illustrates the effect of lengthening the time period for addition of acid on during the sulfonation process.

FIG. 5 illustrates the effect of pre-heating acid before the addition of copolymer, as a means of increasing the reaction temperature

FIG. 6 illustrates a comparison of heating slowly wile dropping polymer beads in pre-heated acid, and the strength results of the copolymer drops compared with slowly heating the acid and copolymer together.

FIG. 7 illustrates the resin strength in terms of percentage of whole, unbroken beads at two hydration rates.

### DETAILED DESCRIPTION OF THE INVENTION

Gel resin bead polymers, composed of crosslinked polymers of singly ethylenically unsaturated monomers, selected from styrene, vinyltoluene, ethyl styrene, α-methylstyrene, or ring-halogenated derivatives thereof, such as chlorostyrene. The polymers have been crosslinked, preferably by copolymerization with crosslinking monomers having more than one copolymerizable C═C double bond per molecule. Examples of crosslinking monomers of this type encompass polyfunctional vinyl aromatics, such as di-or trivinylbenzenes, divinylethylbenzene, divinyltoluene, divinylxylene, divinylethylbenzene, or divinylnapthalene; polyfunctional allylaromatics, such as di-or triallylbenzenes; polyfunctional vinyl- or allylheterocycles, such as trivinyl or triallyl cyanurate or isocyanurate. Crosslinking monomers that have proven particularly useful are divinylbenzene (in a form of an isomer mixture with ethyvinylbenzene or ethyl styrene) and mixtures of divinylbenzene and aliphatic C₆C₁₂ hydrocarbons having 2 or 3 C═C double bonds. The amount of crosslinking monomers varies from 1 to 20 percent by weight, based on the total amount of the polymerizable monomers used.

In the art, starting materials such as acrylic acid, its salts and its esters, particularly its methyl ester and vinylnapthalenes, vinylxylenes, or nitriles or amides of acrylic or methacrylic acids have been added to the monomer mixtures. The present invention may allow the omission of some, or all, of these additives. The present invention can be modified for most of these additives by taking into account the affect the additives have on the resin properties, especially the T_{g} of the crosslinked resin. The inventors expect that the processes of the present invention could be modified for these additional materials.

The copolymerization of monomer and crosslinker is usually initiated by free-radical generators that are monomer-soluble. Examples of preferred free-radical-generating catalysts encompass diacyl peroxides, such as diacetyl peroxide, dibenzoyl peroxide, di-p-chlorobenzoyl peroxide, or lauroyl peroxide; peroxyester, such as tert-butyl. Peroxyacetate, tert-butyl peroctoate, tert-butyl peroxy-2-ethylhexanoate, tert-butyl peroxybenzoate, or dicyclohexylperoxydicarbonate; alkyl peroxides, such as bis (tert-butylperoxy) butane, dicumyl peroxide, or tert-butyl cumyl peroxide; hydroperoxides, such as cumene hydroperoxide or tert-butyl hydroperoxide; ketone peroxides, such as cyclohexanone hydroperoxide, methyl ethyl ketone hydroperoxide, or actylacetone peroxide; or azoisobutyrodinitrile. The free-radical generators may be used in catalytic amounts, i.e. preferably from 0.01 to 2.5 percent by weight, based on the total of monomer and crosslinker.

The crosslinked polymer beads may be prepared using known methods of suspension polymerization. The water-insoluble monomer/cross-linker mixture is added to an aqueous phase that preferably comprises at least one protective colloid for stabilization of the monomer/crosslinker droplets in the disperse phase of the bead polymers produced. Natural or synthetic water-soluble polymers are suitable as protective colloids, e.g. gelatin, starch, polyvinyl alcohol, polyvinyl-pyrrolidone, cellulose ethers or cellulose esters are suitable. The aqueous phase—to—organic phase ratio is preferably in the range of 0.5 to 20. The polymerization temperature depends on the decomposition temperature of the initiator used. It is generally from 50 to 150° C., preferably from 55 to 100° C. The polymerization time is from 0.5 hours to several hours. The resultant beads may have small amounts of residual monomers or other materials not crosslinked into the polymer matrix. Data on T_{g} of cured styrene divinylbenzene copolymer and some data on T_{g} of uncured styrene divinylbenzene copolymer can be found in the literature, J. Bicerano, et. al. “Correlation between Glass Transition Temperature and Chain Structure for Randomly Crosslinked High Polymers”, journal of polymer Science: Polymer Physics, Vol. 34, Issue 13, 30 September 1996, pages 3539-3549.

The resultant bead polymers may be passed to the sulfonation process as they stand, or further used as seeds for larger beads. Methods for subsequent growth of polymer “seeds” by adding polymers are known in the art. The process steps comprise using copolymerizable monomers to swell the seeds of polymer initially obtained, and polymerizing the monomer that has penetrated into the polymer.

In the present invention, sulfonation takes place by mixing sulfuric acid directly with the bead styrene-divinylbenzene copolymer, without the use of a solvent for swelling the copolymer beads. The sulfonation is monitored by visual assessment of the beads under a microscope. The sulfonation proceeds from the exterior of the bead to the interior of the bead (core). The sulfonation front is apparent during the process from the development of a ring within the bead. When the sulfonation is complete, the ring is no longer visible.

The solventless sulfonation of this invention uses sulfuric acid that is available from a number of sources in high concentrations. The amount of acid is preferably about 5 to 10 times the weight of the copolymer. As the sulfuric acid reacts with the copolymer the sulfuric acid and the mixture approaches equilibrium, the conversion of the copolymer to an ion exchange resin slows. The total length of time needed for the reaction will decrease as the initial concentration of acid is increased. However, the inventors have discovered reaction conditions to drive the conversion of polymer and shorten the reaction time, while surprisingly increasing resin strength as measured by the number of whole, unbroken beads (WUBs).

The sulfuric acid added during the reaction is greater than 85 percent, with concentrations over 94 percent preferable for addition during the reaction. Sulfuric acid with concentration greater than 96 percent, including oleum or sulfur trioxide, is most preferred as an additive to the reaction mixture.

The inventors have discovered that the amount of acid, as sulfur trioxide, consumed in the sulfonation reaction is dependent on the initial acid concentration. In addition, the inventors discovered that high initial acid concentrations tend to result in resins with lower numbers of WUBs. This is not predicted from the sulfonation reaction alone.

The inventors discovered that, by starting at an initial sulfuric acid concentration between 88 and 92 percent, the reaction mixture produced higher WUBs. By maintaining the reaction rate, using the addition of concentrated acid described above, the inventors found that they could get both high reaction rates and high strength beads.

Without being bound to any one theory, the inventors believe a possible cause of brittle beads is the formation of sulfone bridges. In the process of sulfonation with sulfuric acid, the acid dissociates to form water and sulfur trioxide. As temperature increases, the concentration of sulfur trioxide increases. Sulfur trioxide reacts with the benzene rings in the copolymer, sulfonating the resin. During the sulfonation reaction, sulfur trioxide is consumed by polymer gel beads, leaving water behind; therefore the concentration of sulfuric acid and sulfur trioxide in the mixture decreases. As the acid concentration decreases, the rate of sulfonation also decreases. In addition, however, sulfur trioxide can react with more than one benzene ring, forming a sulfone bridge (—SO₂—) between benzene rings in the same macromolecule or between macromolecules. The formation of sulfone bridges can lead to non-uniform resin crosslinks, bead distortion, and breakage. Therefore, it is important to control the rate of sulfur trioxide formation to increase the rate of sulfonation without the formation of additional sulfone bridging. The present invention provides methods using temperature and acid concentration to increase the rate of sulfonation while controlling the side reaction of sulfone bridging.

In one embodiment of the present invention, sulfuric acid with concentration greater than 90 percent preferably at least 92 percent, is mixed with the copolymer, and reacted at a constant temperature of about 125 to 150° C. The sulfuric acid is sampled and tested for concentration at intervals of 90 minutes or less. Based on the concentration of the sample, more concentrated sulfuric acid, preferably at least 96 percent is added to the reaction mixture to bring the concentration of sulfuric acid back to above 90 percent, preferably to the starting concentration. Preferably, sampling and addition of sulfuric acid takes place every 30 to 60 minutes, and most preferably, sampling and addition is done continuously during the process, using automated instrumentation such as sonic velocity. In a preferred mode of this embodiment, a maximum number of WUBs and minimum reaction time are achieved by making a reaction by using about 90 to 94 percent sulfuric acid and the copolymer, and then adding sulfuric acid of greater than 94 percent to maintain the initial sulfuric acid concentration in the reaction mixture. This approach slows down the sulfonation rate at the beginning of the reaction, compared to starting with sulfuric acid of over 94 percent in the mixture.

The inventors have also discovered controlling the reaction temperature, with or without control of the acid concentration, can decrease the sulfonation time or increase the strength of the sulfonated beads. The inventors have discovered that the temperature at which sulfonation takes place is influenced by the apparent glass transition temperature, T_{g} of the particular copolymer mixture in the resin bead.

Higher sulfonation temperatures are required with neat sulfonations as compared to sulfonations with swelling solvents. The addition of swelling solvents to the copolymer lowers the average glass transition temperature and permits the sulfonation to proceed at lower temperatures. With neat sulfonations the time to heat up the reactor and reactants becomes a larger portion of the production time. A preferred apparatus for sulfonation includes a jacketed agitated batch or semi-batch reactor equipped with a pump, recirculation loop and external heat exchanger. Optionally filters are used to prevent the copolymer/cation exchange resin from being recirculated. The initial acids and con-add acids can be heated by the external heat exchanger before they are charged to the reactor.

The rate of reaction would be expected to increase with higher temperature in a sulfonation reaction. Dimotsis et al. suggest heating the reaction mixture for (meth) acrylic ester-containing crosslinked bead polymer to and end temperature of 150° to 170° C. by exploiting the heat of mixing and/or heat of reaction.

The inventors have found, however, that a temperature difference as small as 5° C. can significantly decrease the WUBs for a batch of beads. This is especially noticed at high hydration rates. The number of WUB's increases if the mixture is heated slowly after reaching the T_{G}, although the reaction time increases.

When the sulfonation mixture is below the T_{G}, some sulfonation may take place in localized places towards the surface of the bead, causing irregularities in the structure of the bead. Therefore, the inventors have discovered that it is advantageous for the sulfonation mixture to be heated to the T_{G} rapidly, to allow more uniform sulfonation of the beads. Preferably, the sulfonation mixture is heated to a temperature above the T_{g}, most preferably 10 to 50° C. above the T_{g}, provided the polymer is stable at higher temperatures. Heating rates from ambient to above the T_{g} at about 8° C. to 15° C. per minute or faster produce beads with improved surface texture and strength. Faster heating rates may be possible with different equipment, and would be expected to be beneficial.

As an example of this embodiment of the invention, the sulfonation process temperature is increased first quickly, and then slowly during the reaction to allow the reaction rate to be maintained or increased. The mixture of sulfuric acid and copolymer is heated until it reaches the glass transition temperature of the polymer. For copolymers, containing unreacted monomers, used in many gel cation exchange resins, this is a temperature of about 100 to 135° C. The reactor is then heated slowly to a temperature between 140° C. and 150° C. over a period of 3 to 6 hours. In a preferred mode of this embodiment, sulfuric acid with concentration of over 97 percent is combined with the copolymer and heated rapidly to 130° C.; then the temperature increased at a rate of 5 degrees per hour to 140° C. to 150° C. A rapid initial heating to about T_{g} is important in order for this embodiment to provide higher strength and shorter overall reaction time.

In some large production facilities it may be impractical to heat the sulfonation mixture at a rate of temperature exceeding 1° per minute. The time to heat up can be reduced by: 1) retaining the heat of mixing of less concentrated recycle sulfuric acid with more concentrated sulfuric acid or oleum, 2) retaining the heat of reaction, sulfonation, 3) preheating acid before or during addition to the reactor, and 4) adding additional heat transfer area to the reactor system. Additional heat transfer equipment is described in: Donald Q. Kern, “Process Heat Transfer”, McGraw-Hill Book Company, New York, 1950, pages 624-637.

The inventors have discovered that an alternative to heating the reaction mixture quickly is to heat the sulfuric acid to a temperature above the T_{g}, before adding the copolymer beads, gives strong polymer beads. Preferably, the sulfuric acid is heated to a temperature that is high enough that, after the copolymer beads are added, the temperature remains above T_{g}. In an embodiment of this aspect of the invention, sulfuiric acid is heated to about 120 to 150° C. before a copolymer is added. The temperature drops slightly as the copolymer is added to the acid. The reactor is then heated to maintain the temperature at 135° C. to 150° C. for the sulfonation.

In another embodiment of this invention, water formed by the consumption of sulfur trioxide is removed during the sulfonation. This may be done by addition of a dehydrating agent to react with the byproduct. Examples of dehydrating agents include phosphorous pentoxide, described in U.S. Pat. No. 3,238,153 or boric anhydride. Preferably, a dehydrating agent is added at intervals as the amount of by product water increased; more preferably, the dehydrating agent is added continuously during the process, using automated instrumentation to monitor the acid concentration.

In any of the embodiments of the present invention, the sulfonated resin is hydrated following the sulfonation step. The preferred method used in the art on an industrial scale is chromatographic hydration. Chromatographic hydration recovers a relatively high concentration of sulfuric acid for recycle.

As the beads are hydrated, they experience some osmotic shock and may be subject to breakage. In order to minimize the shock, the inventors started hydration process with a high concentration of sulfuric acid followed by lower concentrations of sulfuric acid. De-ionized water is fed into an agitated and cooled vessel filled with concentrated sulfuric acid. The diluted acid is fed into a chromatographic hydration column where it passes over non-hydrated resin. The acid concentration is reduced continuously until the acid is washed by deionizer water.

The concentration of the acid and the flow rate determine the hydration rate of the resin, which can vary from 1.8 to 12 percent per minute under laboratory conditions. Increasing the hydration rate would shorten production times. Faster hydration rates generally produces lower strength resins, as measured by whole, uncracked beads. However, the inventors have discovered that use of the inventive process changes results in sulfonated beads that are resistant to breaking on hydration, even at 12 percent hydration per minute.

In larger production scale equipment the concentration of the hydrating solution increases as the solution flows from the top of the column to the bottom (self sharpening front); therefore the hydration rate is faster at the bottom of the column. In order to achieve a reasonable overall hydration rate, it is preferred to reach a high rate at the top of the column of resin as soon as possible, without causing bead breakage at the bottom as the front moves through.

The inventors have discovered that hydrating at a continuous rate, rather than in a stepwise rate, allows a faster transition to a higher concentration rate. Operating the column on a continuous basis saves time and operator intervention during the hydration process. In addition, the inventors observed savings in the amount of high concentration acid that we could recover and reuse.

Any of the above embodiments may be combined to achieve desired rate and created improved bead formation. For example, the temperature and acid concentration could be increased together.

### EXAMPLES

### Examples 1-10

The lab sulfonator used was a glass vessel with a capacity of 1.7 liters. It had an addition port, a fluoropolymer paddle agitator, and bottom valve. The agitator was driven by a variable speed motor at 200 rpm. Temperature ramping was controlled by an automated process control computer. Acid concentration was determined by first taking a small sample and then titrating it with caustic. Microscopic examination was used to determine when sulfonation was complete, that is no visual polymer core surrounded by sulfonated polymer shell.

### Example 1

An experiment was run using a high initial sulfuric acid concentration, with a slow hydration rate. The copolymer was in situ seeded (semi-batch, Harris, in U.S. Pat. No. 4,564,644 and U.S. Pat. No. 5,068,255) and was polymerized with 5 percent active divinylbenzene by weight from a monomer mixture of 55 percent DVB and 45 percent ethylvinylbenzene in the initial monomer charge. The measured toluene swell cross-link was equivalent to 8 percent DVB. The copolymer bead size was a 20/45 US mesh cut. (That is, the beads were between 354 and 841 microns in size). The copolymer itself had a gel structure. The T_{g} of copolymer/monomer combination was estimated at 117° C. The copolymer was sulfonated by adding 97 percent sulfuric acid and heating at 1.0° C./min to 140° C. and holding the temperature there for two hours. The resin was hydrated by pumping acid into the top of the resin bed such that acid concentration was lowered and the resin was hydrated at 1.25 to 1.75 percent per minute. Acid was removed from the bottom of the column at the same volumetric rate as it is added to the bed at the top. This example produced resin with 88.3 percent Whole Unbroken Beads (WUBs).

### Example 2

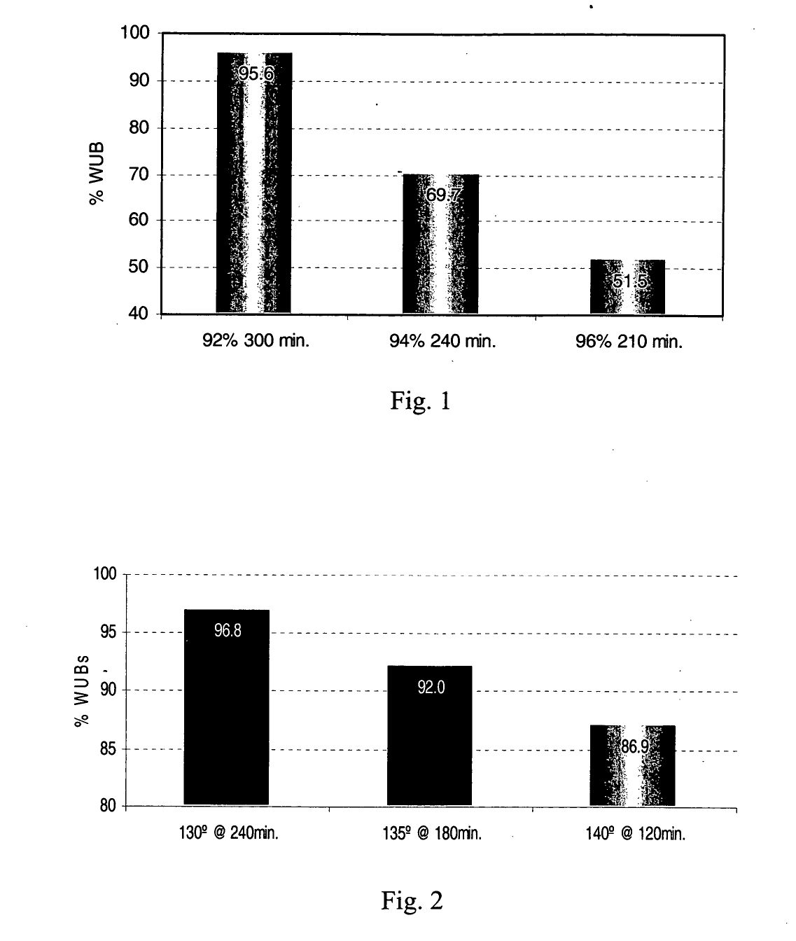

Experiments were run on a second polymer to show the effect of lowering acid concentration at a given temperature. Sulfonation of copolymer containing 8 percent active divinylbenzene with 20/45 US mesh size (That is, the beads were between 354 and 841 microns in size) was carried out at three different initial acid concentrations, heating the copolymer and acid slurry at 1° C./min to 140° C. and holding at 140° C. for the times listed in the chart to achieve complete sulfonation. The T_{g} of copolymer/monomer combination was estimated at 113° C. FIG. 1 shows the result in WUB's at each concentration after hydration at 12 percent/minute. A higher concentration had a lower sulfonation time, but the percentage of whole, uncracked beads dropped.

### Example 3

Experiments were run to demonstrate the effect of adding concentrated sulfuric acid during the sulfonation reaction to keep the sulfonation mixture above 90 percent acid. The copolymer was in situ seeded (semi-batch) and had 5 percent by weight of a monomer mixture of 55 percent DVB and 45 percent ethylvinylbenzene in the initial monomer charge. The measured toluene swell cross-link was equivalent to 8 percent DVB. Copolymer size was a 20/45 US mesh cut. (That is, the beads were between 354 and 841 microns in size). The copolymer itself had a gel structure. The copolymer was loaded into one sulfonator that contained 92 percent acid and set to maintain 145° C., and a second sulfonator with 92 percent acid set to maintain 140° C. Both reactors were heated to their respective set points at 1.0° C./min. Samples of acid and copolymer were taken from each vessel every hour. The sulfuric acid concentration was tested. As the acid concentration dropped in each vessel, 95.7 percent sulfuric acid was added to each sulfonator to bring the concentration back to 92 percent. We evaluated the resin visually, for reduction of the sulfonation line, determine when sulfonation was complete. At 140° C., sulfonation was complete in 6 hours, and the WUBs were 97 percent. The resin was hydrated by pumping acid into the top of the resin bed such that acid concentration is lowered at 1.25 to 1.75 percent per minute. Acid was removed from the bottom of the column at the same volumetric rate as it is added to the bed at the top. At 145° C., sulfonation was complete in 4 hour, and the WUBs were 95.5 percent.

### Example 4

Experiments were done to show the sensitivity of polymer strength to sulfonation temperature. The copolymer was an in situ seeded (semi-batch) styrene-divinylbenzene, made with 5 percent by weight of a monomer mixture of 55 percent DVB and 45 percent ethylvinylbenzene in the initial monomer charge. The measured toluene swell cross-link was equivalent to 8 percent DVB. Copolymer size was a 20/45 US mesh cut. (That is, the beads were between 354 and 841 microns in size). The copolymer itself had a gel structure. The copolymer was sulfonated at 150° C., 130° C. and 135° C. The mixtures were heated at about 1° C. per minute. The sulfonated beads were hydrated at about 1.8 percent per minute. FIG. 2 shows the reaction time needed and the WUB's for each of the sulfonations.

### Example 5

### High Temperature

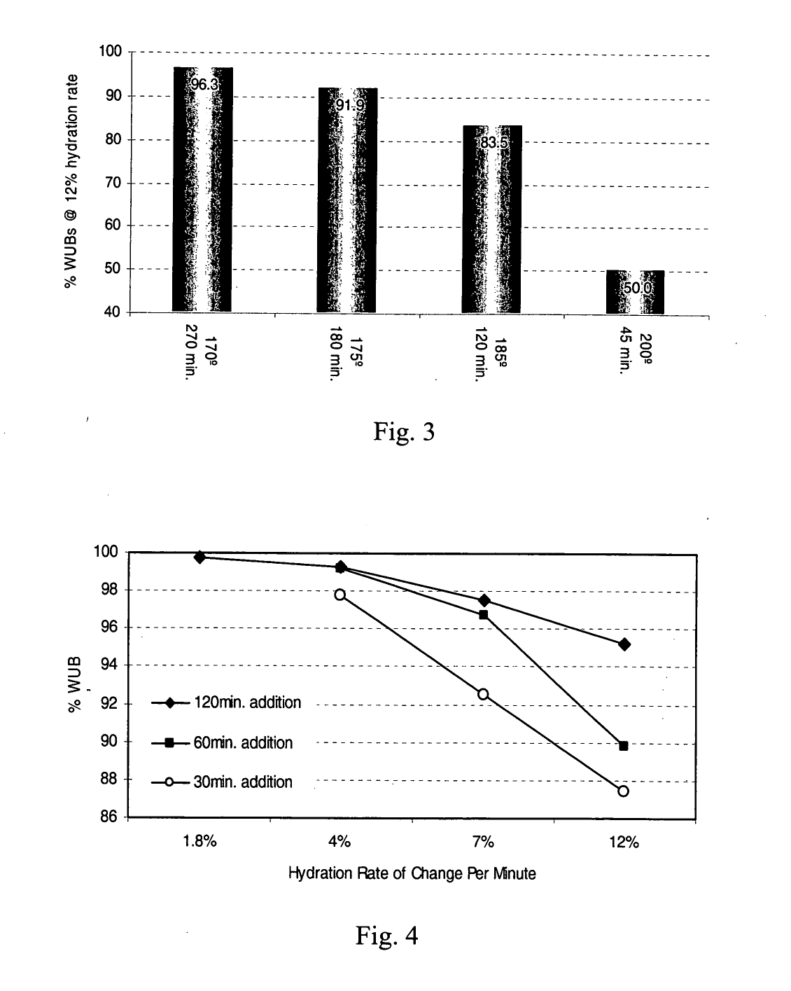

Experiments were run on a second polymer to show the effect of sulfonating at a higher temperature. Sulfonation of a styrene-divinylbenzene copolymer made from 8 percent active divinylbenzene with 20/45 US mesh size (That is, the beads were between 354 and 841 microns in size) was carried out at four different temperatures, using 88 percent acid initial concentration. FIG. 3 shows the result in WUB's at each concentration. Temperatures above 170° C. resulted in a lower sulfonation time, but the percentage of whole, uncracked beads was also lower.

### Example 6

### Effect of Rate of Addition of Acid

The effect of the rate of addition of acid during the sulfonation process on hydration sensitivity was tested. Shown here are the results of changing only the time interval over which 466 mL of 97 percent acid was added to a 140° slurry of 200 mL of 87 percent acid and 150 g of an 8 percent active divinylbenzene copolymer with 20/45 US mesh size (That is, the beads were between 354 and 841 microns in size). This information shows that lengthening the period of time for acid addition reduces the impact of rapid hydration on the reduction of whole, uncracked beads.

### Example 7

### Quick Increase of Initial Reaction Temperature

The copolymer was in situ seeded (semi-batch) and had 5 percent by weight of a monomer mixture of 55 percent DVB and 45 percent ethylvinylbenzene in the initial monomer charge. The measured toluene swell cross-link was equivalent to 8 percent DVB. Copolymer size was a 20/45 US mesh cut. (That is, the beads were between 354 and 841 microns in size). The copolymer itself had a gel structure. The copolymer was loaded into the sulfonator and 95.7 percent sulfuric acid was added to the vessel. The sulfonator temperature was set to rise quickly to 130° C. (10° C./minute), and then increase slowly to 145° C. over 3 hours. The resin was hydrated by pumping acid into the top of the resin bed such that acid concentration is lowered at 1.25 to 1.75 percent per minute. Acid was removed from the bottom of the column at the same volumetric rate as it is added to the bed at the top.

The resulting resin had WUBs of about 98 percent.

### Example 8

### Pre-Heating Sulfuric Acid Before Adding Resin

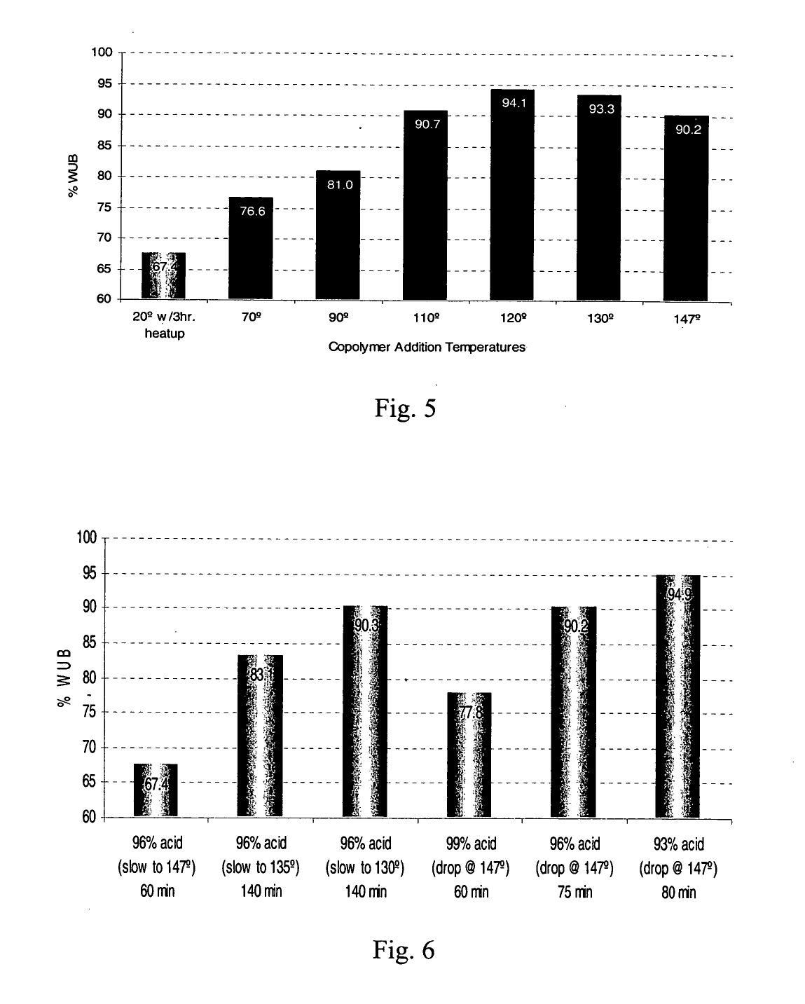

Experiments were conducted to determine the effect of pre-heating acid before the addition of copolymer, as a means of increasing the reaction temperature. Sulfuric acid with a concentration of 96 percent acid was heated to several temperatures before adding copolymer containing 6.5 percent active divinylbenzene having a US mesh size of 20-60 (That is between 250 and 841 microns in diameter) 6K resin beads. The T_{g} of copolymer/monomer combination was estimated at 110° C. The mixture was then heated at 2° C. per minute to 147° and held for 75 minutes to complete the sulfonation. The sulfonated resin was hydrated at 7 percent per minute. The results in percent whole, uncracked beads are shown in FIG. 5.

### Example 9

### Comparison of Heating Slowly with Dropping Polymer Beads in Pre-Heated Acid

Experiments were conducted where sulfuric acid was heated to 147° C. before the copolymer was dropped into the hot acid; the temperature was then temporarily increased to 160° C. to simulate a possible exothermic reaction induced temperature spike often seen in production. FIG. 6 shows the strength results of some of these 147° copolymer drops compared with slowly heating the acid and copolymer together.

### Example 10

### Combining Fast Heat Up and Addition of Concentrated Acid

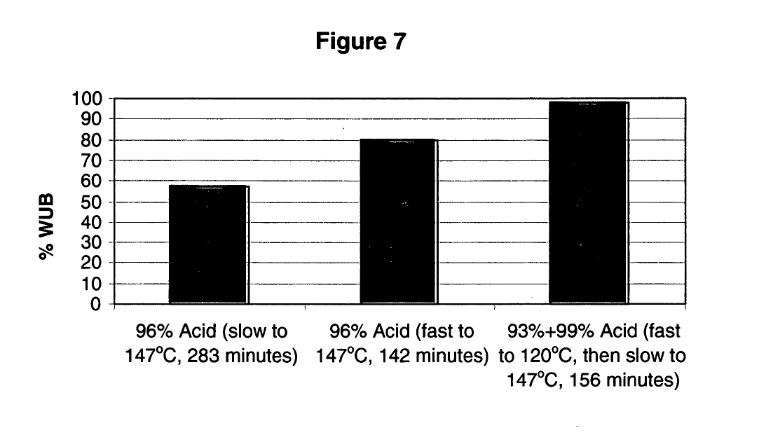

Copolymer containing 6.5 percent active divinylbenzene having a US mesh size of 20-60 (That is between 250 and 841 microns in diameter) was sulfonated under three different conditions to show the effect of rapid heat up and combining rapid heat up with addition of concentrated acid on the resin strength, in terms of percent WUBs, and the length of time required for the sulfonation. In the first reaction, the copolymer and 96 percent sulfuric acid were mixed at room temperature and heated at 0.75° C./niin to 147° C., and then held at 147° C. until the sulfonation was complete (120 min) for a total sulfonation time of 283 minutes. In the second reaction the copolymer and 96 percent acid were mixed at room temperature and then heated to 147° C. at 10° C./min and held at that temperature until the reaction was complete (130 min) for a total sulfonation time of 142 minutes. In the third reaction half of the total amount of acid (93 percent concentration) was mixed with the copolymer and heated at 10° C./min to 120° C., then heated at 1° C./min to 147° C. Addition of 99 percent concentration acid, one half of the total amount was added starting when the copolymer/acid slurry reached 135° C. over 60 minutes. The reaction was held at 147° C. for 120 minutes, for a total sulfonation time of 160 minutes. The percent WUBs for the three resins after hydration at 7 percent/min is presented in FIG. 7.

### Example 11

### Combining Dropping Polymer Beads in Pre-Heated Acid and Addition of Concentrated Acid

The lab sulfonator used was a glass vessel with a capacity of 2.0 liters. It had an addition port, a fluoropolymer paddle agitator, and bottom valve. The agitator was driven by a variable speed motor. Temperature ramping was controlled by an automated process control computer. Acid concentration was determined by sonic analysis (SensoTech GmbH). The sulfonation reaction was considered complete when the acid concentration remained constant.

800 ml of 96.2 percent sulfuric acid was added to the vessel. The contents were heated to 125° C. and 300 gm of 6.5 percent divinylbenzene copolymer, screened minus 841 μm plus 250 μm, was added to the hot sulfuric acid. The contents were heated to 147° C. at a rate of 1° C./minute. At 135° C. addition of 400 ml of 99.0 percent sulfuric acid was started to the vessel. The acid addition rate was set at 6.7 ml/minute for a total addition time of 1 hour. The reactor was held at 147° C. for 1 hour and then cooled to room temperature. A portion of the sulfonated copolymer was hydrated at 7 percent/minute. The properties were: 5.16 meq/gm dry weight capacity, 54.1 percent water retention capacity, and 99.1 percent whole uncracked beads.

1. A process for preparation of gel cationic exchange resins by sulfonation of styrene-divinylbenzene copolymer gel resin beads comprising reacting sulfuric acid with the beads, without the addition of a chlorine-containing swelling agent, in a mixture of the sulfuric acid and the beads, at a temperature above the glass transition temperature of the copolymer beads.

2. The process of claim 1 wherein concentrated sulfuric acid is added to the mixture during sulfonation to maintain a concentration of sulfuric acid in the mixture of greater than about 90 percent by weight.

3. The process of claim 1 wherein the sulfonated bead is hydrated at a rate of up to about 12 percent per minute.

4. The process of claim 1 wherein the sulfonation takes place in less than about 8 hours.

5. A process for preparation of gel cationic exchange resins by sulfonation of gel-like styrene-divinylbenzene copolymer beads comprising reacting sulfuric acid with the beads, without the addition of a chlorine-containing swelling agent, in a mixture of the sulfuric acid and the beads wherein concentrated sulfuric acid is added to the mixture during sulfonation to maintain a concentration of sulfuric acid in the mixture of greater than about 90 percent by weight.

6. A process for preparation of gel cationic exchange resins by sulfonation of gel-like styrene-divinylbenzene copolymer beads having cross-link density of greater than 5 percent, the process comprising sulfonating the bead copolymers in sulfuric acid, for less than 8 hours at 125 to 160° C., without the addition of a chlorine-containing swelling agent.

7. The method of claim 6 wherein sulfuric acid is added during the reaction to maintain a concentration of sulfuric acid of greater than 90 percent.

8. The method of claim 6 where sulfonation is carried out at 140 to 145° C. for 4 to 6 hours, and an initial sulfuric acid concentration of 92 percent is maintained during the sulfonation reaction by the addition of concentrated sulfuric acid.

9. The method of claim 6 where the reaction temperature is increased from less than about 130° C. to more than 140° C. during the sulfonation reaction.

10. The method of claim 6 where the initial sulfuric acid concentration is 95.7 percent and the temperature rises from 130° C. to 145° C. over three hours.

11. The method of claim 6 where a dehydrating agent is added during sulfonation.

12. The method of claim 6 where the reaction conditions are such that little or no reaction occurs prior to the temperature of the copolymer reaching the T_{g} of the copolymer, but the entire sulfonation is done in less than 8 hours. Conditions included are:

13. The method of claim 12 which includes rapidly heating a mixture of acid and copolymer at 8-15° C./minute to >10° C. above the T_{g} of the copolymer.

14. The method of claim 12 which includes adding copolymer to acid that is >10° C. above the Tg of the copolymer.

15. The method of claim 12 which includes starting with a mixture of low concentration acid (90 percent) and copolymer, and heating to >10° C. above the Tg of the copolymer and then adding concentrated acid.

16. The method of claim 12 which includes heating a mixture of copolymer and 90 percent acid to a temperature >150° C.
